(19) United States
(12) Patent Application Publication
(10) Pub. No.: US 2021/0103165 A1
(43) Pub. Date: Apr. 8, 2021

(54) ELECTRO-OPTIC DEVICE

(71) Applicants: TDK Corporation, Tokyo (JP); FUJITSU OPTICAL COMPONENTS LIMITED, Kanagawa (JP)

(72) Inventors: Shinji IWATSUKA, Tokyo (JP); Kenji SASAKI, Tokyo (JP); Hiroki HARA, Tokyo (JP); Yasuhiro OHMORI, Kanagawa (JP); Masaharu DOI, Kanagawa (JP); Shintaro TAKEUCHI, Kanagawa (JP); Yoshihiko YOSHIDA, Kanagawa (JP); Yoshinobu KUBOTA, Kanagawa (JP)

(21) Appl. No.: 16/832,647

(22) Filed: Mar. 27, 2020

(30) Foreign Application Priority Data
Mar. 29, 2019 (JP) 2019-065989

(51) Int. Cl. G02F 1/035; G02F 1/225

(52) U.S. Cl. CPC G02F 1/0356; G02F 2001/212; G02F 1/2255

(57) ABSTRACT

An electro-optic device is provided with a substrate, an optical waveguide formed of a lithium niobate film with a ridge shape on the substrate, and an electrode that applies an electric field to the optical waveguide. The optical waveguide includes a modulation waveguide provided in an electric field application region applied with the electric field and having a thickness of 1 μm or larger and a bent waveguide provided in a region other than the electric field application region and having a curvature radius of 16 μm or larger and 80 μm or smaller.

### BACKGROUND OF THE INVENTION

### Field of the Invention

The present invention relates to an electro-optic device used in the fields of optical communication and optical measurement and, more particularly, to a structure of an optical waveguide.

### Description of Related Art

Communication traffic has been remarkably increased with widespread Internet use, and optical fiber communication is increasingly significant. The optical fiber communication is a technology that converts an electric signal into an optical signal and transmits the optical signal through an optical fiber and has a wide bandwidth, a low loss, and high resistance to noise.

As a system for converting an electric signal into an optical signal, there are known a direct modulation system using a semiconductor laser and an external modulation system using an optical modulator. The direct modulation system does not require the optical modulator and is thus low in cost, but has a limitation in terms of high-speed modulation and, thus, the external modulation system is used for high-speed and long-distance applications.

Optical modulators are one of the typical electro-optic devices, and Mach-Zehnder optical modulators in which an optical waveguide is formed by titanium (Ti) diffusion in the vicinity of a surface of a single-crystal lithium niobate substrate have been put to practical use. The Mach-Zehnder optical modulator uses an optical waveguide (Mach-Zehnder optical waveguide) having a Mach-Zehnder interferometer structure that demultiplexes light emitted from one light source into two, makes the demultiplexed lights pass through different paths, and multiplexes the lights to cause interference. As such Mach-Zehnder optical modulators, high-speed optical modulators of 40 Gb/s or more are now commercially available. However, these high-speed optical modulators have the drawback of having a length as large as approximately 10 cm.

On the other hand, JP 2006-195383A, JP 2014-006348A, JP 2015-118371A, and JP 2017-129834A disclose a Mach-Zehnder optical modulator using a lithium niobate film. The optical modulator using the lithium niobate film achieves significant reduction in size and driving voltage as compared with an optical modulator using the lithium niobate single-crystal substrate.

In general, an optical waveguide used in an electro-optic device needs to operate in a single mode. This is because, in a multi-mode operation, a change in an effective refractive index upon application of an electric field differs between modes, causing modulation characteristics to be deteriorated significantly.

As a method for suppressing the multi-mode, the following configurations are proposed. For example, JP 2003-240992A describes a waveguide element and a waveguide device having a bent waveguide constituted by a core with a spot size allowing multi-mode excitation and having a radius of curvature for suppressing high-order mode propagation. Further, JP 2010-151973A proposes, in order to prevent excitation of a higher-order mode itself in a bent waveguide, an optical semiconductor device including: a first optical waveguide with a first width; a second optical waveguide with a second width smaller than the first width, the second optical waveguide being connected to the first optical waveguide and having a bent part; and a third optical waveguide with a third width larger than the second width, the third optical waveguide being connected to the second optical waveguide.

In the optical waveguide using the lithium niobate film, the single mode can be realized by reducing the film thickness of the lithium niobate film as much as possible; however, this may cause not only a deterioration in light confinement, but also an increase in drive voltage. By increasing the thickness of the lithium niobate film, it is possible to improve the light confinement to thereby reduce the drive voltage; however, the light propagation mode in the optical waveguide becomes a multimode to deteriorate modulation characteristics.

### SUMMARY

The present invention has been made in view of the above situations, and the object thereof is to provide an electro-optic device having a low drive voltage and obtaining satisfactory modulation characteristics.

To solve the above problem, an electro-optic device according to an aspect of the present invention includes: a substrate; an optical waveguide formed of a lithium niobate film with a ridge shape on the substrate; and an electrode that applies an electric field to the optical waveguide, wherein the optical waveguide includes a modulation waveguide provided in an electric field application region applied with the electric field and having a thickness of 1 μm or larger and a bent waveguide provided in a region other than the electric field application region and having a curvature radius of 16 μm or larger and 80 μm or smaller.

According to the present invention, it is possible to realize an optical waveguide having a low drive voltage in the electric field application region. Further, a part of the optical waveguide that is provided in a region other than the electric field application region has a bent waveguide, so that a high-order mode can be previously removed to allow the multimode optical waveguide in the electric field application region to operate substantially in a single mode, thus making it possible to obtain satisfactory modulation characteristics.

The electro-optic device according to the present invention preferably further has a dummy pattern which is formed of a lithium niobate film with a ridge shape on the substrate and which is disposed in the vicinity of the bent waveguide. In this case, the bent waveguide is preferably connected to the dummy pattern through a slab part. With this configuration, leakage of the high-order mode can be promoted in the bent waveguide.

The optical waveguide preferably includes a Mach-Zehnder optical waveguide. With this configuration, there can be provided a Mach-Zehnder optical waveguide having a low drive voltage and satisfactory modulation characteristics.

An electro-optic device according to another aspect of the present invention includes: a substrate; an optical waveguide formed of a lithium niobate film with a ridge shape on the substrate; and an electrode that applies an electric field to the optical waveguide, wherein the optical waveguide includes a modulation waveguide provided in an electric field application region applied with the electric field and having a thickness of 1 μm or larger and a bent waveguide provided in a region other than the electric field application region, and a dummy pattern which is formed of the lithium niobate film formed in a ridge shape on the substrate is disposed in the vicinity of the bent waveguide.

According to the present invention, it is possible to realize an optical waveguide having a low drive voltage in the electric field application region. Further, a part of the optical waveguide that is provided in a region other than the electric field application region has a bent waveguide, and the dummy pattern is provided in the vicinity of the bent waveguide, so that a high-order mode can be removed in advance to allow the multimode optical waveguide in the electric field application region to operate substantially in a single mode, thus making it possible to obtain satisfactory modulation characteristics.

According to the present invention, there can be provided an electro-optic device having a low drive voltage and satisfactory modulation characteristics.

### BRIEF DESCRIPTION OF THE DRAWINGS

The above and other objects, features and advantages of this invention will become more apparent by reference to the following detailed description of the invention taken in conjunction with the accompanying drawings, wherein:

FIG. 1 is a schematic plan view illustrating the configuration of an electro-optic device according an embodiment of the present invention;

FIG. 2 is a schematic cross-sectional view taken along line A-A′ in FIG. 1, which illustrates the structure of the electro-optic device within the electric field application region R1;

FIG. 3 is a graph illustrating the relationship between the film thickness of the lithium niobate film and a half-wavelength voltage Vπ;

FIGS. 4A and 4B are plan views illustrating the configuration of the unnecessary mode removal section 5;

FIGS. 5A to 5C are schematic plan views illustrating modifications of the layout of the unnecessary mode removal section;

FIGS. 6A to 6C are images showing the result of evaluating the influence that the bent waveguide 2R constituting the unnecessary mode removal section 5 has on the waveguide mode by simulation; and

FIG. 7A and 7B are graphs illustrating the propagation losses of the respective fundamental mode TM0 and first-order mode TM1 in the bent waveguide, in which the horizontal axis represents a curvature radius R (μm) and the vertical axis represents a propagation loss (dB/mm).

### DETAILED DESCRIPTION OF THE EMBODIMENTS

Preferred embodiments of the present invention will now be explained in detail with reference to the drawings.

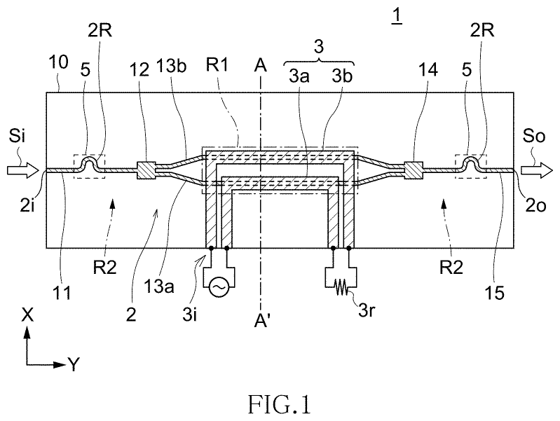

FIG. 1 is a schematic plan view illustrating the configuration of an electro-optic device according an embodiment of the present invention.

As illustrated in FIG. 1, an electro-optic device 1 according to the present embodiment is an optical modulator and includes a substrate 10, an optical waveguide 2 formed on the substrate 10 and an RF signal electrode 3 provided so as to partially overlap the optical waveguide 2 in a plan view.

The optical waveguide 2 is a Mach-Zehnder optical waveguide and includes an input waveguide 11, a demultiplexor 12, first and second modulation waveguides 13a and 13b, a multiplexor 14, and an output waveguide 15 in this order from an optical input port 2i toward an optical output port 2o. The input waveguide 11 extending from the optical input port 2i is connected to the first and second modulation waveguides 13a and 13b through the demultiplexor 12, and the first and second modulation waveguides 13a and 13b are connected to the output waveguide 15 through the multiplexor 14. Input light Si input to the optical input port 2i is demultiplexed by the demultiplexor 12, the demultiplexed lights travel through the respective first and second modulation waveguides 13a and 13b and multiplexed by the multiplexor 14, and the multiplexed light is output from the optical output port 2o as modulated light So.

The RF signal electrode 3 has a first signal electrode 3a provided along the first modulation waveguide 13a and a second signal electrode 3b provided along the second modulation waveguide 13b. One ends of the first and second signal electrodes 3a and 3b are RF signal input ports 3i, to which a differential signal (modulation signal) is input. The other ends of the first and second signal electrodes 3a and 3b are connected to each other through a terminal resistor 3r. The first and second modulation waveguides 13a and 13b are applied with an electric field generated from the first and second signal electrodes 3a and 3b.

A pair of bias electrodes may be provided at positions overlapping the first and second modulation waveguides 13a and 13b, respectively, so as to apply DC bias. One ends of the pair of bias electrodes are each an input terminal of the DC bias. The pair of bias electrodes may be positioned closer to the optical input port 2i side or optical output port 2o side of the optical waveguide 2 than the formation area of the first and second signal electrodes 3a and 3b is. Further, the pair of bias electrodes may be omitted, and instead, a modulated signal including superimposed DC bias may be input to the first and second signal electrodes 3a and 3b.

The optical waveguide 2 according to the present embodiment is a multimode optical waveguide that can propagate not only light of a fundamental mode, but also light of a high-order mode. The multimode optical waveguide according to the present embodiment is a ridge type optical waveguide having a thickness of 1.0 μm or larger. In particular, the first and second modulation waveguides 13a and 13b within an electric field application region R1 overlapping the first and second signal electrodes 3a and 3b are configured as the multimode optical waveguide, and a thickness of 1.0 μm or larger allows enhancement of light confinement to reduce a drive voltage. When the bias electrode is provided together with the RF signal electrode 3, the electric field application region R1 further includes the formation area of the bias electrode in addition to the formation area of the RF signal electrode 3.

The input waveguide 11 and output waveguide 15, each of which is a part of the optical waveguide 2 that is provided in a region R2 outside the electric field application region R1, each have the unnecessary mode removal section 5 that removes the high-order mode light. Although details will be described later, the unnecessary mode removal section 5 is a bent waveguide 2R with a small curvature radius. When the thickness of the optical waveguide 2 is increased, a drive voltage can be reduced; however, the waveguide mode becomes a multimode to deteriorate modulation characteristics. In the present embodiment, when the unnecessary mode removal section 5 is provided in the region R2 outside the electric field application region R1, there occurs no problem of an increase in drive voltage, and it is possible to attenuate the high-order mode light to allow propagation of only the fundamental mode light. Therefore, the multimode optical waveguide within the electric field application region R1 can be operated substantially in a single mode.

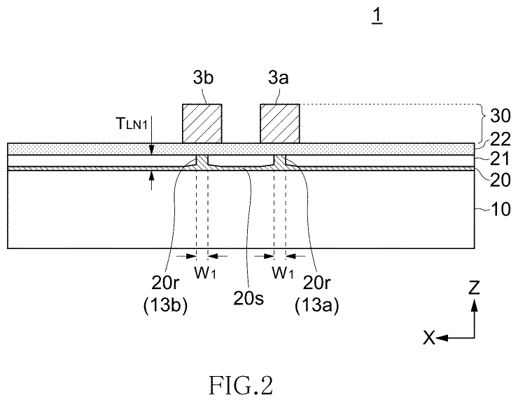

FIG. 2 is a schematic cross-sectional view taken along line A-A′ in FIG. 1, which illustrates the structure of the electro-optic device within the electric field application region R1.

As illustrated in FIG. 2, the electro-optic device 1 according to the present embodiment has a multilayer structure in which the substrate 10, a waveguide layer 20, a protective layer 21, a buffer layer 22, and an electrode layer 30 are laminated in this order.

The substrate 10 is, e.g., a sapphire substrate, and the waveguide layer 20 formed of an electro-optic material, such as a lithium niobate, is formed on the surface of the substrate 10. The waveguide layer 20 has the first and second modulation waveguides 13a and 13b each formed by a ridge part 20r.

The protective layer 21 is formed in an area not overlapping the first and second modulation waveguides 13a and 13b in a plan view. The protective layer 21 covers the entire area of the upper surface of the waveguide layer 20 excluding portions where the ridge parts 20r are formed, and the side surfaces of each of the ridge parts 20r are also covered with the protective layer 21, so that scattering loss caused due to the roughness of the side surfaces of the ridge part 20r can be prevented. The thickness of the protective layer 21 is substantially equal to the height of the ridge part 20r of the waveguide layer 20. There is no particular restriction on the material of the protective layer 21 and, for example, silicon oxide (SiO₂) may be used.

As described above, a ridge thickness T_{LN1} of the first and second modulation waveguides 13a and 13b is preferably 1 μm or larger. Thus, the optical waveguide 2 becomes a multimode optical waveguide that can propagate not only the fundamental mode light, but also at least light of a first-order mode in which a light intensity distribution has two peaks in the film thickness direction. A ridge width W₁ of the first and second modulation waveguides 13a and 13b is preferably 0.8 μm to 1.4 μm.

The buffer layer 22 is formed on the upper surfaces of the ridge parts 20r so as to prevent light propagating through the first and second modulation waveguides 13a and 13b from being absorbed by the first and second signal electrodes 3a and 3b. The buffer layer 22 is preferably formed of a material having a lower refractive index than the waveguide layer 20 and a high transparency, such as Al₂O₃, SiO₂, LaAlO₃, LaYO₃, ZnO, HfO₂, MgO, or Y₂I₃, and the thickness thereof may be about 0.2 μm to 1 μm. Although the buffer layer 22 covers not only the upper surfaces of the respective first and second modulation waveguides 13a and 13b, but also the entire underlying surface including the upper surface of the protective layer 21 in the present embodiment, it may be patterned so as to selectively cover only around the upper surfaces of the first and second modulation waveguides 13a and 13b. Further, the buffer layer 22 may be directly formed on the upper surface of the waveguide layer 20 with the protective layer 21 omitted.

The film thickness of the buffer layer 22 is preferably as large as possible in order to reduce light absorption by an electrode and preferably as small as possible in order to apply a high electric field to the first and second modulation waveguides 13a and 13b. The electrode light absorption and electrode application voltage have a trade-off relation, so that it is necessary to set adequate film thickness according to the purpose. The dielectric constant of the buffer layer 22 is preferably as high as possible, because the higher the dielectric constant thereof, the more VπL (index representing electric field efficiency) is reduced. Further, the refractive index of the buffer layer 22 is preferably as low as possible, because the lower the refractive index thereof, the thinner the buffer layer 22 can be. In general, a material having a high dielectric constant has a higher refractive index, so that it is important to select a material having a high dielectric constant and a comparatively low refractive index considering the balance therebetween. For example, Al₂O₃ has a specific dielectric constant of about 9 and a refractive index of about 1.6 and is thus preferable. LaAlO₃ has a specific dielectric constant of about 13 and a refractive index of about 1.7, and LaYO₃ has a specific dielectric constant of about 17 and a refractive index of about 1.7 and are thus particularly preferable.

The electrode layer 30 is provided with the first and second signal electrodes 3a and 3b. The first signal electrode 3a is provided overlapping the ridge part 20r corresponding to the first modulation waveguide 13a so as to modulate light traveling inside the first modulation waveguide 13a and is opposed to the first modulation waveguide 13a through the buffer layer 22. The second signal electrode 3b is provided overlapping the ridge part 20r corresponding to the second modulation waveguide 13b so as to modulate light traveling inside the second modulation waveguide 13b and is opposed to the second modulation waveguide 13b through the buffer layer 22.

A ground electrode may be provided on the electrode layer 30. For example, a first ground electrode is provided on the side opposite the second signal electrode 3b with respect to the first signal electrode 3a and in the vicinity of the first signal electrode 3a, and a second ground electrode is provided on the side opposite the first signal electrode 3a with respect to the second signal electrode 3b and in the vicinity of the second signal electrode 3b. Further, a third ground electrode may be provided between the first and second signal electrodes 3a and 3b.

Although the waveguide layer 20 is not particularly limited in type as long as it is formed of an electro-optic material, it is preferably formed of lithium niobate (LiNbO₃). This is because lithium niobate has a large electro-optic constant and is thus suitable as the constituent material of an electro-optic device such as an optical modulator. Hereinafter, the configuration of the present embodiment when the waveguide layer 20 is formed using a lithium niobate film will be described in detail.

Although the substrate 10 is not particularly limited in type as long as it has a lower refractive index than the lithium niobate film, it is preferably a substrate on which the lithium niobate film can be formed as an epitaxial film. Specifically, the substrate 10 is preferably a sapphire single-crystal substrate or a silicon single-crystal substrate. The crystal orientation of the single-crystal substrate is not particularly limited. The lithium niobate film can be easily formed as a c-axis oriented epitaxial film on single-crystal substrates having different crystal orientations. Since the c-axis oriented lithium niobate film has three-fold symmetry, the underlying single-crystal substrate preferably has the same symmetry. Thus, the single-crystal sapphire substrate preferably has a c-plane, and the single-crystal silicon substrate preferably has a (111) surface.

The “epitaxial film” refers to a film having the crystal orientation of the underlying substrate or film. Assuming that the film surface extends in X-Y plane and that the film thickness direction is the Z-axis, the crystal of the epitaxial film is uniformly oriented along the X-axis and Y-axis on the film surface and along the Z-axis. For example, the epitaxial film can be confirmed by first measuring the peak intensity at the orientation position by 2θ-θ X-ray diffraction and secondly observing poles.

Specifically, first, in the 2θ-θ X-ray diffraction measurement, all the peak intensities except for the peak intensity on a target surface must be 10% or less, preferably 5% or less, of the maximum peak intensity on the target surface. For example, in a c-axis oriented epitaxial lithium niobate film, the peak intensities except for the peak intensity on a (00L) surface are 10% or less, preferably 5% or less, of the maximum peak intensity on the (00L) surface. (00L) is a general term for (001), (002), and other equivalent surfaces.

Secondly, poles must be observable in the measurement. Under the condition where the peak intensities are measured at the first orientation position, only the orientation in a single direction is proved. Even if the first condition is satisfied, in the case of nonuniformity in the in-plane crystalline orientation, the X-ray intensity is not increased at a particular angle, and poles cannot be observed. Since LiNbO₃ has a trigonal crystal system, single-crystal LiNbO₃ (014) has 3 poles. For the lithium niobate film, it is known that crystals rotated by 180° about the c-axis are epitaxially grown in a symmetrically-coupled twin crystal state. In this case, three poles are symmetrically coupled to form six poles. When the lithium niobate film is formed on a single-crystal silicon substrate having a (100) plane, the substrate has four-fold symmetry, and 4×3=12 poles are observed. In the present invention, the lithium niobate film epitaxially grown in the twin crystal state is also considered to be an epitaxial film.

The lithium niobate film has a composition of LixNbAyOz. A denotes an element other than Li, Nb, and O. The number x ranges from 0.5 to 1.2, preferably 0.9 to 1.05. The number y ranges from 0 to 0.5. The number z ranges from 1.5 to 4, preferably 2.5 to 3.5. Examples of the element A include K, Na, Rb, Cs, Be, Mg, Ca, Sr, Ba, Ti, Zr, Hf, V, Cr, Mo, W, Fe, Co, Ni, Zn, Sc, and Ce, alone or in combination. The lithium niobate film preferably has a film thickness of 2 μm or smaller. This is because a high-quality lithium niobate film having a thickness of larger than 2 μm is difficult to form. The lithium niobate film having an excessively small thickness cannot completely confine light, allowing the light to penetrate therethrough and reach into the substrate 10 or the buffer layer 22. Application of an electric field to the lithium niobate film may therefore cause a small change in the effective refractive index of the optical waveguide. Thus, the lithium niobate film in the electric field application region R1 preferably has a film thickness of 1 μm or larger, and more preferably, 1.3 μm or larger.

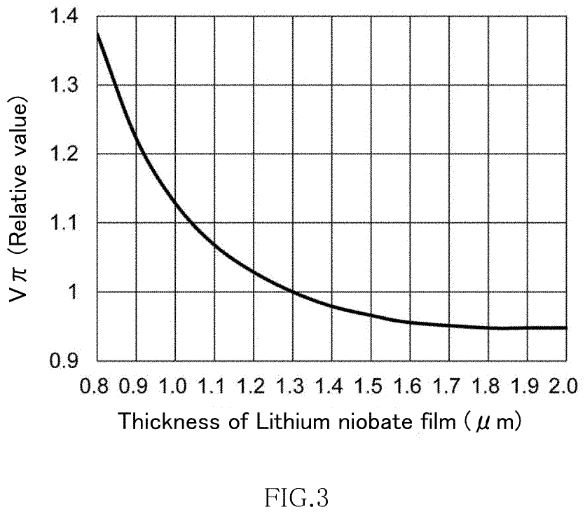

FIG. 3 is a graph illustrating the relationship between the film thickness of the lithium niobate film and a half-wavelength voltage Vπ. The horizontal axis represents the film thickness (μm) of the lithium niobate film, and the vertical axis represents the relative value of the half-wavelength voltage Vπ with a value when the film thickness of the lithium niobate film is 1.3 μm set as a reference.

As illustrated in FIG. 3, under the condition that the wavelength λ of light is 1550 nm which is used in an optical communication system, when the film thickness of the lithium niobate film is set to a value smaller than 1 μm, the half-wavelength voltage Vπ abruptly increases, making it difficult to make the half-wavelength voltage Vπ equal to or less than 3V which is a practical voltage value. This is because when the film thickness is small, light confinement into the lithium niobate film becomes weak to effectively reduce an electro-optic effect. On the other hand, when the film thickness of the lithium niobate film is set to 1.0 μm or larger, the half-wavelength voltage Vπ can be kept to a low level, whereby a drive voltage can be reduced. When the film thickness of the lithium niobate film is 1.3 μm or larger, light confinement becomes sufficiently strong, so that the Vπ hardly changes even when the film thickness exceeds this value.

The lithium niobate film is preferably formed using a film formation method, such as sputtering, CVD, or sol-gel process. Application of an electric field along the c-axis of the lithium niobate perpendicular to the main surface of the substrate 10 can change the optical refractive index in proportion to the electric field. In the case of the single-crystal substrate made of sapphire, the lithium niobate film can be directly epitaxially grown on the sapphire single-crystal substrate. In the case of the single-crystal substrate made of silicon, the lithium niobate film is epitaxially grown on a clad layer (not illustrated). The clad layer (not illustrated) has a lower refractive index than the lithium niobate film and should be suitable for epitaxial growth. For example, a high-quality lithium niobate film can be formed on a clad layer (not illustrated) made of Y₂O₃.

As a formation method for the lithium niobate film, there is known a method of thinly polishing or slicing the lithium niobate single crystal substrate. This method has an advantage that the same characteristics as those of the single crystal can be obtained and can be applied to the present invention.

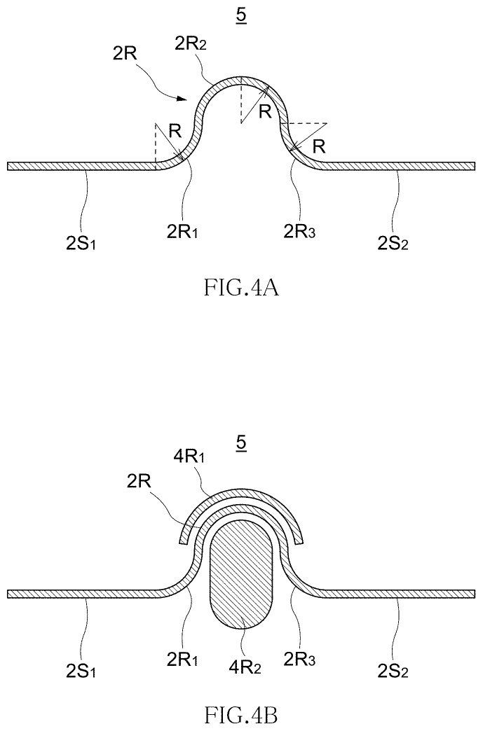

FIGS. 4A and 4B are plan views each illustrating the configuration of the unnecessary mode removal section 5.

As illustrated in FIG. 4A, the unnecessary mode removal section 5 is constituted by a bent waveguide 2R. The bent waveguide 2R according to the present embodiment includes a first corner section 2R₁ that changes the extending direction of a linear waveguide 2S₁, a second corner section 2R₂ that has a U-turn shape, and a third corner section 2R₃ that is curved so as to return to the extension line of the linear waveguide 2S₁. The third corner section 2R₃ is connected to a linear waveguide 2S₂ disposed on the extension line of the linear waveguide 2S₁. That is, the bent waveguide 2R is configured to once deviate from the extending direction of the linear waveguide 2S₁ and then return to the original course. However, the shape of the bent waveguide 2R and the number of the corner sections are not particularly limited, and the bent waveguide 2R can have various shapes.

The curvature radius of each of the first to third corner sections 2R₁ to 2R₃ constituting the bent waveguide 2R is preferably 16 μm or larger and 80 μm or smaller. When the curvature radius is smaller than 16 μm, propagation loss of the fundamental mode TM0 abruptly increases, and when the curvature radius is larger than 80 μm, a high-order mode removal effect to be brought about by providing the bent waveguide 2R cannot be practically obtained.

As illustrated in FIG. 4B, the unnecessary mode removal section 5 may have a dummy pattern (dummy waveguide) in the vicinity of the bent waveguide 2R. Although the illustrated unnecessary mode removal section 5 has an outer dummy pattern 4R₁ provided along the outer periphery of the bent waveguide 2R and an inner dummy pattern 4R₂ provided along the inner periphery of the bent waveguide 2R, it may have only the outer dummy pattern 4R₁ or inner dummy pattern 4R₂.

The dummy patterns 4R₁ and 4R₂ are provided to promote leakage of a high-order mode from the bent waveguide 2R and are formed of a lithium niobate film like the bent waveguide 2R. The dummy pattern is preferably provided as close to the bent waveguide 2R as possible. Specifically, the distance between the bent waveguide 2R and the dummy patterns 4R₁, 4R₂ is preferably 0.5 μm or larger and 20 μm or smaller and, more preferably, 1 μm or larger and 10 μm or smaller. With this configuration, high-order mode light propagating through the bent waveguide 2R is absorbed by the dummy pattern, so that an effect of leaking the high-order mode from the bent waveguide 2R can be further enhanced.

Like the bent waveguide 2R, the dummy patterns 4R₁ and 4R₂ are each preferably formed of a lithium niobate film formed in a ridge shape on the substrate 10. In particular, as the first modulation waveguide 13a is connected to the second modulation waveguide 13b through a slab part 20s in FIG. 2, the dummy patterns 4R₁ and 4R₂ are preferably connected to the bent waveguide 2R through a slab part. When the bent waveguide 2R is connected to the dummy patterns 4R₁ and 4R₂ through the slab part, the high-order mode light propagating through the bent waveguide 2R is absorbed by the dummy patterns 4R₁ and 4R₂ through the slab part, so that the effect of leaking the high-order mode from the bent waveguide 2R can be further enhanced.

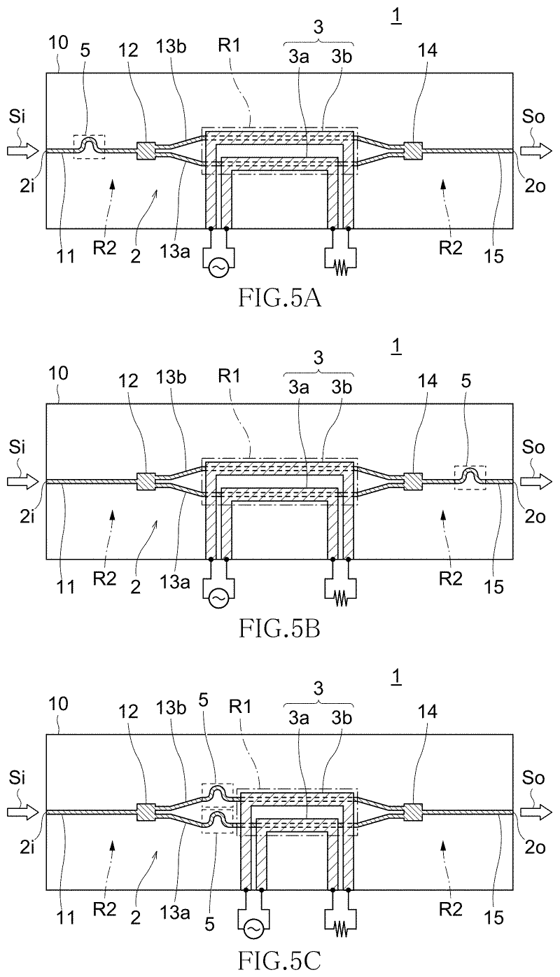

FIGS. 5A to 5C are schematic plan views illustrating modifications of the layout of the unnecessary mode removal section.

As illustrated in FIG. 5A, the unnecessary mode removal section 5 may be provided only on the input waveguide 11. Alternatively, as illustrated in FIG. 5B, the unnecessary mode removal section 5 may be provided only on the output waveguide 15. Further alternatively, as illustrated in FIG. 5C, the unnecessary mode removal section 5 may be provided on the first and second modulation waveguides 13a and 13b in the region R2 outside the electric field application region R1.

As described above, when the unnecessary mode removal section 5 is provided at a part of the optical waveguide 2 positioned in the region R2 outside the electric field application region R1, it is possible to remove the high-order mode light, particularly, light of a first-order mode TM1 in advance to allow the multimode optical waveguide to operate substantially in a fundamental mode TM0 even when the optical waveguide 2 in the electric field application region R1 is configured as the multimode optical waveguide, thus making it possible to prevent deterioration in modulation characteristics.

As described above, in the electro-optic device 1 according to the present embodiment, the optical waveguide 2 in the electric field application region R1 is configured as the multimode optical waveguide having a thickness of 1 μm or larger, thereby allowing a drive voltage to be reduced. Further, the unnecessary mode removal section 5 is provided in the region R2 outside the electric field application region R1, so that it is possible to remove the high-order mode light in advance to allow the multimode optical waveguide to operate substantially in the single mode, thus making it possible to provide satisfactory modulation characteristics.

While the preferred embodiment of the present invention has been described, the present invention is not limited to the above embodiment, and various modifications may be made within the scope of the present invention, and all such modifications are included in the present invention.

For example, the electro-optic device according to the present invention is not limited to an optical modulator, but is applicable to other various types of electro-optic devices.

### [Examples]

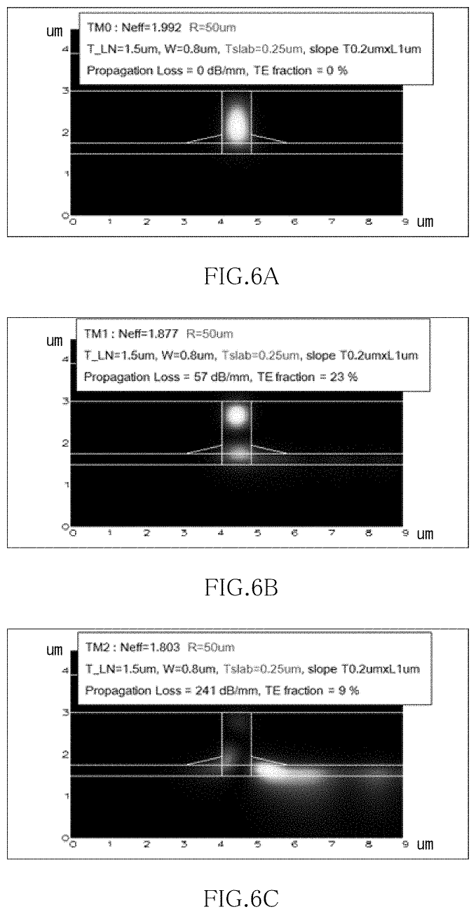

Influences that the bent waveguide 2R constituting the unnecessary mode removal section 5 has on the waveguide mode were evaluated by simulation. Settings were made as follows: curvature radius R of the bent waveguide (first to third corner sections)=50 μm; thickness T_{LN} of the waveguide=1.5 μm; ridge width W₁=0.8 μm; maximum slab thickness L_{slab1}=45 μm; minimum slab thickness L_{slab2}=0.25 μm; slab thickness change range Lₛₗₒₚₑ=1.0 μm; and wavelength λ of light=1.55 μm. The results are illustrated in FIGS. 6A to 6C.

As illustrated in FIG. 6A, the propagation loss of the fundamental mode TM0 in the bent waveguide is 0 dB/mm, thus revealing that the fundamental mode TM0 propagates without leaking. Further, as illustrated in FIG. 6B, the propagation loss of the first-order mode TM1 is 57 dB/mm, thus revealing that the first-order mode TM1 leaks through the slab part. Further, as illustrated in FIG. 6C, the propagation loss of the second-order mode TM2 is 241 dB/mm, thus revealing that the second-order mode TM2 is more likely to leak than the first-order mode TM1.

Next, influences that the curvature radius of the bent waveguide 2R has on the fundamental mode TM0 and firs-order mode TM1 were examined. The basic configuration of the bent waveguide was the same as those in the above simulation for the waveguide mode except that the curvature radius was used as a parameter.

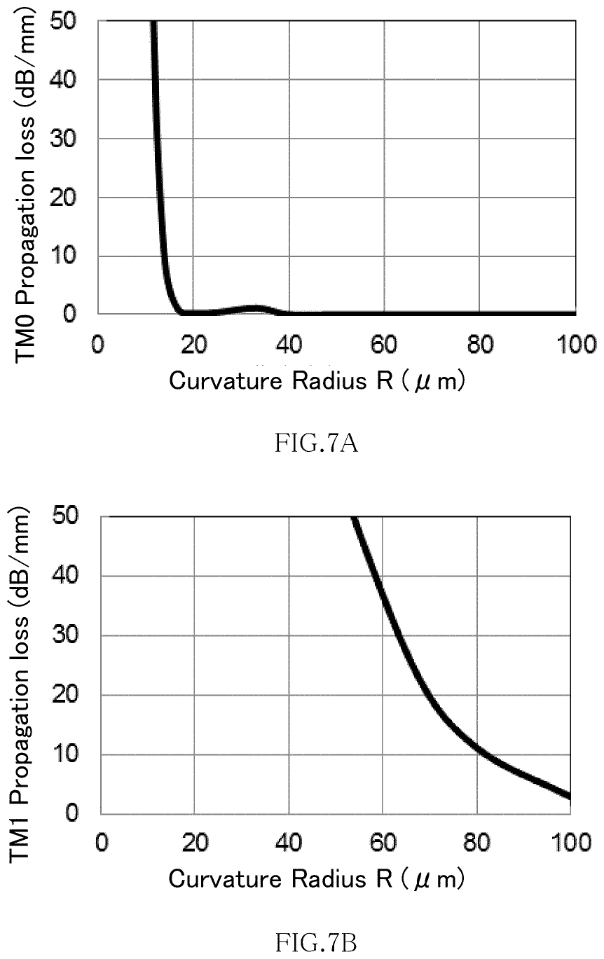

FIG. 7A and 7B are graphs illustrating the propagation losses of the respective fundamental mode TM0 and first-order mode TM1 in the bent waveguide. The horizontal axis represents a curvature radius R (μm) and the vertical axis represents a propagation loss (dB/mm).

As illustrated in FIG. 7A, the propagation loss of the fundamental mode TM0 becomes 10 dB/mm or more when the curvature radius R is smaller than 16 μm, exhibiting an abrupt increase in the propagation loss. This reveals that the curvature radius R of the bent waveguide needs to be set to 16 μm or larger.

Further, as illustrated in FIG. 7B, the propagation loss of the first-order mode TM1 becomes less than 10 dB/mm when the curvature radius R is larger than 80 μm, failing to obtain the unnecessary mode removal effect. This reveals that the unnecessary mode removal effect can be obtained when the curvature radius R of the bent waveguide is 80 μm or smaller.

What is claimed is:

1. An electro-optic device comprising:
a substrate;
an optical waveguide formed of a lithium niobate film with a ridge shape on the substrate; and
an electrode that applies an electric field to the optical waveguide, wherein
the optical waveguide includes a modulation waveguide provided in an electric field application region applied with the electric field and having a thickness of 1 μm or larger and a bent waveguide provided in a region other than the electric field application region and having a curvature radius of 16 μm or larger and 80 μm or smaller.

2. The electro-optic device as claimed in claim 1 further has a dummy pattern which is formed of a lithium niobate film with a ridge shape on the substrate and which is disposed in the vicinity of the bent waveguide.

3. The electro-optic device as claimed in claim 2, wherein the bent waveguide is connected to the dummy pattern through a slab part.

4. The electro-optic device as claimed in claim 1, wherein the optical waveguide includes a Mach-Zehnder optical waveguide.

5. An electro-optic device comprising:
a substrate;
an optical waveguide formed of a lithium niobate film with a ridge shape on the substrate; and
an electrode that applies an electric field to the optical waveguide, wherein
the optical waveguide includes a modulation waveguide provided in an electric field application region applied with the electric field and having a thickness of 1 μm or larger and a bent waveguide provided in a region other than the electric field application region, and
a dummy pattern which is formed of the lithium niobate film formed in a ridge shape on the substrate is disposed in the vicinity of the bent waveguide.
